(19) United States
(12) Patent Application Publication
(10) Pub. No.: US 2011/0274841 A1
(43) Pub. Date: Nov. 10, 2011

(54) COIL SPRING COATING PORTION FORMING METHOD AND APPARATUS

(75) Inventor: Yasuo HAYAKAWA, Gyoda-shi (JP)

(73) Assignee: SHOWA CORPORATION, Gyoda-shi (JP)

(21) Appl. No.: 13/187,208

(22) Filed: Jul. 20, 2011

Related U.S. Application Data
(62) Division of application No. 12/139,480, filed on Jun. 15, 2008.

(30) Foreign Application Priority Data
Nov. 20, 2007 (JP) 2007-301014

(51) Int. Cl. B05D 7/00; B05D 3/00; B05D 1/18; B05D 3/02

(52) U.S. Cl. 427/314

(57) ABSTRACT

In a coating portion forming method of a coil spring, the method includes steps of heating the coil spring, dipping the heated coil spring in a thermosetting resin solution, and reheating the coil spring which is pulled up from the thermosetting resin solution.

### BACKGROUND OF THE INVENTION

1. Field of the Invention

The present invention relates to a coating portion forming method of a coil spring that is preferably used as a suspension spring for a vehicle.

2. Description of the Related Art

In the coil spring used as the suspension spring for a vehicle, adjacent spring element wires come into contact with each other so as to generate an abnormal noise on the basis of a vibration, an impact or the like generated at a time of traveling. Conventionally, in order to prevent the abnormal noise, there has been proposed a provision of a resin coating portion in a part of the coil spring.

A coating portion forming method of a coil spring described in Japanese Patent Application Publication (JP-B) No. 59-8430 (patent document 1) rolls at least a part in an axial direction of the coil spring preheated to a predetermined surface temperature within a container accommodating a thermoplastic resin fine particle having a melting point which is 250.degree. C. or less in an inner portion, heating and melting the resin fine particle attached to a spring element wire of the coil spring, and thereafter cooling and solidifying the resin fine particle.

In the coating portion forming method of the coil spring described in the patent document 1, it is necessary to use the thermoplastic resin as the resin, for coating the resin fine particle to the coil spring. Since the fine particle of the thermoplastic resin is solidified after being melted by the heat of the coil spring, there is a case that the resin melting around the coil spring remains within the container as it is without being attached to the coil spring, an unevenness is generated in the resin coating portion of the coil spring such as the resin is attached to the next coil spring as an agglomeration, whereby it is hard to uniformly coat each of the coil springs.

### SUMMARY OF THE INVENTION

An object of the present invention is to form a uniform resin coating portion on a coil spring.

The present invention relates to a coating portion forming method of a coil spring having a step of heating the coil spring, a step of dipping the heated coil spring in a thermosetting resin solution, and a step of reheating the coil spring which is pulled up from the thermosetting resin solution.

Further, the present invention relates to a coating portion forming apparatus of a coil spring which is used for executing the coating portion forming method of the coil spring, in which a dipping tank of the thermosetting resin solution and a reheating and drying furnace of the coil spring are installed sequentially in an outlet side of the heating and drying furnace after painting of the coil spring in a painting line.

### BRIEF DESCRIPTION OF THE DRAWINGS

The present invention will be more fully understood from the detailed description given below and from the accompanying drawings which should not be taken to be a limitation on the invention, but are for explanation and understanding only.

FIG. 1 is a schematic view showing a coil spring;

FIG. 2 is a schematic view showing a coating portion forming apparatus of the coil spring; and

FIG. 3 is a diagram showing one example of an integrated production step of a manufacturing line of the coil spring.

### DESCRIPTION OF THE PREFERRED EMBODIMENTS

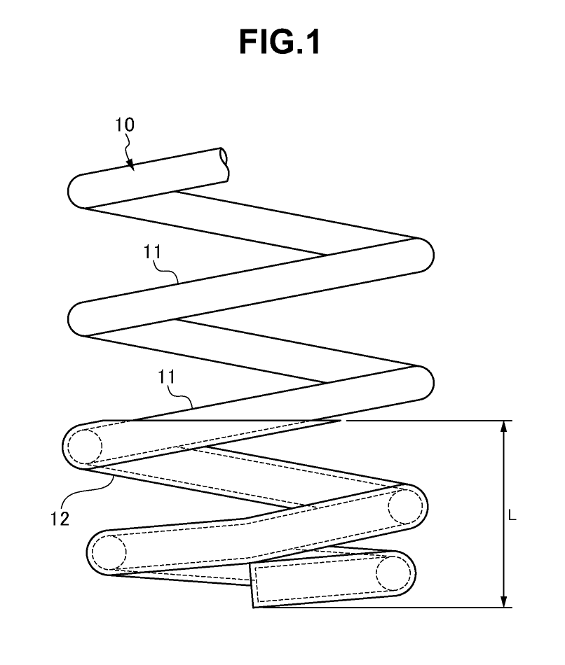

A coil spring 10 is structured, as shown in FIG. 1, such that a resin coating portion 12 is formed in a spring element wire 11 of a spring terminal portion, and prevents an abnormal noise caused by a contact between adjacent spring element wires 11 and 11.

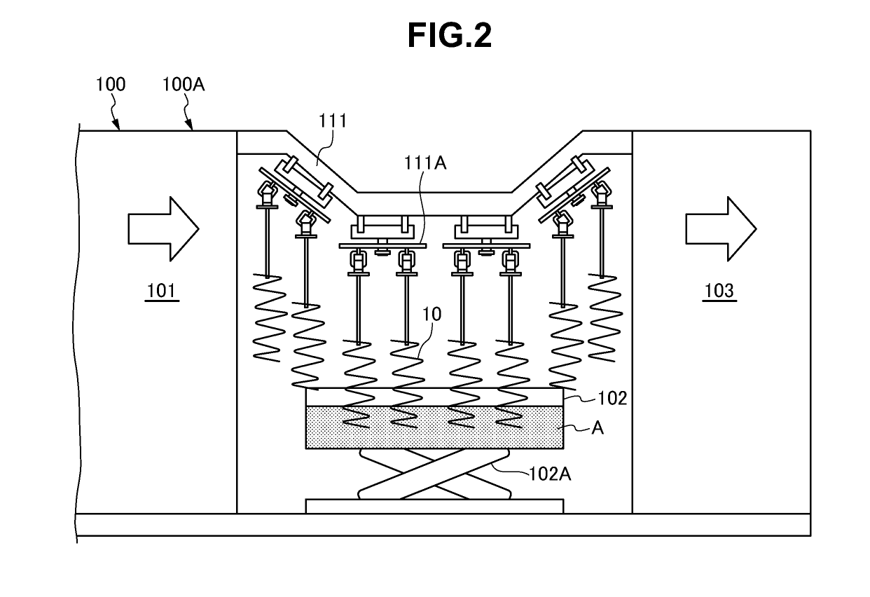

The resin coating portion 12 of the coil spring 10 is formed in accordance with the following procedure. At this time, the resin coating portion 12 of the coil spring 10 can be formed by a coating portion forming apparatus 100A installed within a painting line 100, for example, as shown in FIG. 2. The coating portion forming apparatus 100A is structured by sequentially installing a dipping tank 102 of a thermosetting resin solution A and a reheating and drying furnace 103 of the coil spring 10 in an outlet side of a heating and drying furnace 101 after painting of the coil spring 10 in the painting line 100.

(1) Step of Heating Coil Spring 10

The step heats and dries the coil spring 10 to a predetermined temperature, for example, 180.degree. C.+−0.20.degree. C. by the heating and drying furnace 101 which heats and dries (bakes and dries) the fine particle after painting the fine particle in the painting line 100, by utilizing a heating and drying step after painting the coil spring 10.

(2) Step of Dipping Heated Coil Spring 10 in Thermosetting Resin Solution A

The step dips the heated coil spring 10 (the coil spring 10 has a remaining heat (for example, 100.degree. C.) heated by the heating and drying furnace 101) in the dipping tank 102 of the thermosetting resin solution. A spring terminal portion of the coil spring 10 suspended from a lifting tool 111A of a conveyor 111 of the painting line 100 is dipped in the dipping tank 102 for a fixed dipping time, for example, only for one minute at a fixed feed speed. A dipping depth of the coil spring 10 in the dipping tank 102, a length L (for example, 2 to 3 mm) of the resin coating portion 12 by extension can be regulated by changing a height of the dipping tank 102 by a lifter 102A of the dipping tank 102.

The thermosetting resin solution can employ, for example, an acrylic sol (a kind of plastic sol including an acrylic polymer as a main component), for example, at a normal temperature.

(3) Step of Reheating Coil Spring 10 Pulled Up from Thermosetting Resin Solution

The step reheats and dries (re-bakes and dries) the coil spring 10 for a predetermined time, for example, five minutes, at a predetermined temperature, for example, 180.degree. C.+−0.20.degree. C., by the reheating and drying furnace 103.

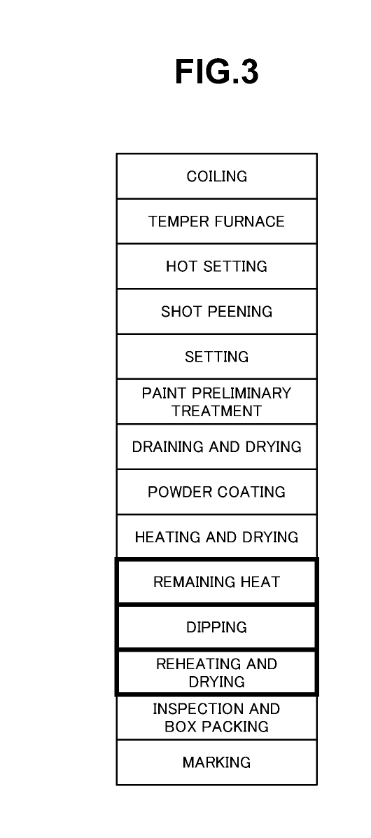

Accordingly, the manufacturing line including the painting line 100 of the coil spring 10 finishes the integrated production of the coil spring 10 via a coiling step, a temper furnace step, a hot setting step, a shot peening step, a setting step, a paint preliminary treatment step, a draining and drying step, a fine particle painting step, a heating and drying step (the heating and drying furnace 101), a remaining heat step, a dipping step (the dipping tank 102), a reheating and drying step (the reheating and drying furnace 103), an inspecting and box packing step, and a marking step, for example, as shown in FIG. 3.

In accordance with the present embodiment, the following operations and effects can be achieved.

(a) The liquid thermosetting resin attached to the coil spring 10 is hardened by the heat of the coil spring 10, and the uniform resin coating portion 12 having the uniform fixed thickness is formed. The stable resin coating portion 12 which is resistant to heat (has a heat resistance) is formed by further hardening the resin coating portion 12 on the basis of the thereafter reheating of the coil spring 10.

(b) The heated and hardened acrylic resin has a flexibility so as to form the resin coating portion 12 of the coil spring 10, and effectively prevents the abnormal noise caused by the contact between the adjacent spring element wires. Further, the acrylic resin is excellent in durability and a resistance to environment.

(c) It is possible to harden the liquid thermosetting resin attached to the coil spring 10 by utilizing the heat applied to the coil spring 10 in the heating and drying step after painting the coil spring 10.

(d) The coating portion forming apparatus 100A of the coil spring 10 is structured by sequentially installing the dipping tank 102 of the thermosetting resin solution A, and the reheating and drying furnace 103 of the coil spring 10 in the outlet side of the heating and drying furnace 101 after painting the painting line 100 of the coil spring 10. The resin coating portion 12 can be formed in the coil spring 10 by installing the coating portion forming apparatus 100A in a part of the manufacturing line including the painting line 100 of the coil spring 10, and it is possible to improve a productivity of the coil spring 10. It is possible to regulate the dipping depth of the coil spring 10, and the length of the resin coating portion 12 (a coating position in a second winding, a third winding or the like) by extension, by changing the height of the dipping tank 102 of the thermosetting resin solution. It is possible to regulate the coating thickness of the resin coating portion 12 by changing the dipping time of the coil spring 10.

As heretofore explained, embodiments of the present invention have been described in detail with reference to the drawings. However, the specific configurations of the present invention are not limited to the embodiments but those having a modification of the design within the range of the present invention are also included in the present invention.

Although the invention has been illustrated and described with respect to several exemplary embodiments thereof, it should be understood by those skilled in the art that the foregoing and various other changes, omissions and additions may be made to the present invention without departing from the spirit and scope thereof. Therefore, the present invention should not be understood as limited to the specific embodiment set out above, but should be understood to include all possible embodiments which can be embodied within a scope encompassed and equivalents thereof with respect to the features set out in the appended claims.

We claim:

1. A coating portion forming method of a coil spring comprising the steps of: heating the coil spring; dipping the heated coil spring in a thermosetting resin solution; and reheating the coil spring which is pulled up from the thermosetting resin solution.

2. The coating portion forming method of a coil spring according to claim 1, wherein said thermosetting resin solution is constituted by an acrylic sol.

3. The coating portion forming method of a coil spring according to claim 1, wherein the step of heating said coil spring is constituted by a heating and drying step after painting said coil spring.

4. The coating portion forming method of a coil spring according to claim 2, wherein the step of heating said coil spring is constituted by a heating and drying step after painting said coil spring.
